(19) United States
(12) Patent Application Publication
(10) Pub. No.: US 2017/0351126 A1
(43) Pub. Date: Dec. 7, 2017

(54) ELECTRONIC DISPLAYS

(71) Applicant: HEWLETT-PACKARD DEVELOPMENT COMPANY, L.P., HOUSTON, TX (US)

(72) Inventors: WEI KUANG CHU, TAIPEI CITY (TW); KUAN-TING WU, TAIPEI CITY (TW); HUI LENG LIM, HOUSTON, TX (US)

(21) Appl. No.: 15/535,806

(22) PCT Filed: Feb. 25, 2015
(86) PCT No.: PCT/US2015/017441

§ 371 Date: Jun. 14, 2017

(51) Int. Cl. G02F 1/13; G02F 1/155; G02F 1/1334; G02F 1/1333; G02F 1/1335; G02F 1/1343; G02F 1/137

(52) U.S. Cl. CPC G02F 1/1323; G02F 1/13439; G02F 1/155; G02F 1/137; G02F 1/13338; G02F 1/1335; G02F 1/1334; G02F 2201/44

(57) ABSTRACT

One example provides an article. The article comprises a substrate that is an electronic display; a first device disposed over the substrate; and a second device disposed over the substrate. The first device comprises: a first electrode; a second electrode; and polymer dispersed liquid crystals disposed between the first electrode and the second electrode. The second device comprises: an electrochromic layer comprising an electrochromic material; and a third electrode in electrical contact with the electrochromic layer.

### BACKGROUND

Display devices such as liquid crystal display devices, light-emitting diode display devices, video display units, and the like, are common in many areas of work and everyday life in the industrialized countries of the world. It is not unusual for such devices to display information which is private and confidential, and intended only for the benefit of a user of the display device, or for a limited group of people who work with the information displayed.

Such a display, for example, may be found in an automated teller machine (“ATM”). Such a display may be a visual display unit (“VDU”) in an office displaying, for example, personnel records, medical records, or other confidential information, In many cases, it is not possible or practical to restrict movement of people in the vicinity of the display who have no need to see the displayed information. In such cases, there is a possibility that the displayed information may be seen by unauthorized people who may use the information to the disadvantage of a person or persons that the information concerns.

### BRIEF DESCRIPTION OF THE DRAWINGS

The drawings are provided to illustrate various examples of the subject matter described herein related to an electronic display and are not intended to limit the scope of the subject matter. The drawings are not necessarily to scale.

FIGS. 1-7 are schematic diagrams showing different examples of the article described herein.

FIG. 8 shows a flowchart illustrating one example of a method of using an article described herein.

### DETAILED DESCRIPTION

Laptop or notebook computers are often used in crowded, public places such as airplanes for writing personal or otherwise confidential information. Under such circumstances, there is generally a concern that a nearby person, such as the person in the next airplane seat, may be reading sensitive material. This concern may keep many people from using a laptop computer in many instances when its use would be particularly convenient. If the computer is used in this way, sensitive data may be stolen.

In view of the aforementioned challenges related to the electronic displays, the Inventors have recognized and appreciated the advantages of an electronic display having privacy protection and is eye-friendly. Following below are more detailed descriptions of various examples related to an electronic display, particularly a display with privacy protection and capability to filter light of certain wavelengths. The various examples described herein may be implemented in any of numerous ways.

Provided in one aspect of the examples is an article, comprising: a substrate that is an electronic display; a first device disposed over the substrate; and a second device disposed over the substrate; wherein the first device comprises: a first electrode; a second electrode; and polymer dispersed liquid crystals disposed between the first electrode and the second electrode; and the second device comprises: an electrochromic layer comprising an electrochromic material; and a third electrode in electrical contact with the electrochromic layer.

Provided in another aspect of the examples is an article, comprising: a substrate that is an electronic display; a first device disposed over at least a portion of the substrate; and a second device disposed over at least a portion of the first device; wherein the first device comprises: a first electrode in contact with the substrate; a second electrode; and polymer dispersed liquid crystals disposed in a matrix comprising an insulating material between the first electrode and the second electrode; and the second device comprises: a first insulating layer comprising the insulating material; an electrochromic layer comprising an electrochromic material disposed over at least a portion of the first insulating layer; a third electrode disposed over and in electrical contact with at least a portion of the electrochromic layer; a second insulating layer comprising the insulating material disposed over at least a portion of the third electrode.

Provided in another aspect of the examples is a method of using an article, comprising: controlling transmission of light through the article using a first voltage; and controlling absorption of light through the article using a second voltage; wherein the article comprising: a substrate that is an electronic display; a first device disposed over at least a portion of the substrate; and a second device disposed over at least a portion of the first device; wherein the first device comprises: a first electrode; a second electrode; and polymer dispersed liquid crystals disposed between the first electrode and the second electrode; the second device comprises: an electrochromic layer comprising an electrochromic material; and a third electrode in electrical contact with the electrochromic layer; and wherein the first voltage is applied to the first device and the second voltage is applied to the second device.

Electronic Display

The substrate described herein may be an electronic display. An electronic display herein may refer to any device, or component thereof, that permits transmission and output of presentation of information electronically to a user (e.g., viewer). The information may be visual, audio, etc. In one example, the display has the capability of displaying at least visual signals. In one example, the display is an electronic visual display. The display may be a part of an electronic device.

An electronic device herein may refer to any device comprising at least one electrical circuit. Thus, in one example, the housing that comprises the composite described herein may be external to the electrical circuit. The electronic device may be a consumer electronic device. An electronic device may refer to portable/mobile electronic device. An electronic device here may refer to a computer, a memory storage, a display, a signal transmitting device, and the like. A computer may refer to a desktop, a laptop, a tablet, a phablet, a tablone, and the like. A storage unit may refer to the hardware of a hard drive, a server, a processor, and the like. A display may refer to a monitor, a liquid crystal display (“LCD”), a television, and the like. A signal transmitting device may refer to a device transmitting any type of signal, including light, sound, heat, and the like. In one example, the electronic device is a mobile phone.

The display may be at least one of a liquid crystal display, an organic light-emitting diode (“OLEO”), a polymer light-emitting diode (“PLED”), a plasma display, electrowetting display, and a bi-stable display. One example of a bi-stable display is electrophoretic ink, or E Ink® available from E Ink Corporation. Another example of a bi-stable display is cholesteric liquid crystal display, which contains cholesteric liquid crystals (or “chiral nematic liquid crystals” having a helical structure). Other types of electronic displays are also possible.

Privacy Device

The first device in the articles described herein may be employed to provide privacy to the user of the article by altering the transmission of light through the devices so as to control the viewability of the electronic display substrate. In one example, the privacy device is a privacy filter/screen. Privacy may be provided during the use of a laptop computer by restricting the viewing angle through which the privacy device (e.g., privacy screen) may be viewed, so that only the person sifting directly in front of the screen may read the data written on it. This angle may be limited by holding a privacy device across the front of the computer display screen, so that the display screen may only be viewed through the privacy device.

A privacy device may be placed over the display substrate to inhibit individuals sitting nearby from seeing the contents of the display. The privacy device may be integrated with the display, or may be added to the display detachably as an electronic privacy filter. In one example, the privacy device is integrated with the display as one single device article.

The viewing angle, related to viewability of the display as a result of the privacy device, may be controlled (e.g., increase or decrease) by liquid crystal materials. For example, polymer dispersed liquid crystal (“PDLC”) material may be electronically switched between a relatively transparent state and a light scattering state. In the light scattering state of the PDLC, the viewing angle of the display may be increased. Various combinations of layers of liquid crystal materials and/or other optical materials with electrically modifiable properties may be utilized to construct an electronic privacy.

PDLCS may include liquid crystal droplets that are dispersed in a solid polymer matrix. The solid polymer matrix may comprise any suitable material. For example, the matrix may comprise at least one of a glass and a plastic. The glass may be, for example, soda lime glass, alkali glass, boron silicate glass, non-alkali metal aluminum silicate glass, fused silica glass, etc. The plastic may be for example, optical substrates, such as poly(methyl methacrylate) (“PMMA”), polyethylene terephthalate (“PET”), cyclic olefin copolymer (“COC”), polycarbonate, and polyimide; transparent plastics; and transparent plastic composites. The crystals may have any suitable dimensions, depending on the application. “Dimension” herein may refer to length, width, height, diameter, etc., depending on the geometry. By changing the orientation of the liquid crystals with an electric field, it is possible to vary the light being transmitted through the PDLC, thereby varying the intensity of transmitted light.

In one example, the crystals are a few micrometers across in dimension. In one example, the crystals have a shape of cylinders and each cylinder has a diameter of between about 10 μm and about 150 μm—e.g., between about 50 μm and about 100 μm. Other values are also possible. In one example, the cylinder shaped crystals may have a height of between about 100 μm and about 250 μm—e.g., between about 150 μm and about 200 μm. Other values are also possible. The cylinder-shaped droplets may be placed in an array, separating from each other by any suitable distance. In one example, each pair of crystals are separated from each other by a distance of between about 200 μm and about 350 μm—e.g., between about 250 μm and about 300 μm. Other values are also possible.

In one example, a privacy device comprising a PDLC material provides two states: a transparent state and a scattering state. In the transparent state, the light from the electronic display pixels may pass through the PDLC material relatively unchanged, providing the relatively more private mode. In the scattering state, the light from the pixels may be scattered, providing the relatively more public mode. The relatively more private and public modes may correspond to the respective viewing angles of the display image. In the transparent state, the visibility of the display corresponds to the relatively narrow viewing angle of the underlying electronic display substrate. In the scattering state, the visibility of the display will correspond to a relatively wider viewing angle provided the view angle enhancement of the PDLC material (e.g. the light scattering effect of the PDLC). The PDLC state may be controlled by at least one voltage. Thus, switching between public and private modes may be performed by the user without applying external devices to achieve privacy.

A layer comprising PDLC may be sandwiched between two electrodes. In one example, this layer comprising PDLC is sandwiched between two layers of glass or plastic each of which includes a thin layer of a transparent, conductive material, which serve as electrodes to apply a voltage across the PDLC layer. In one example, the aforedescribed controlling of the PDLC state may be through applying a voltage across the two electrodes. The voltage may be from a voltage or power source internal to the article or external to the article. In one example, the power source for the PDLC, through the two electrodes, may be drawn from a processor-based device. For example, direct current (“DC”) power may be provided from the battery of the electronic device, of which the electronic display is a part. In another example, when the electronic device is plugged in for charging, power may be provided from the alternating current (“AC”) adapter or from the power conversion circuit within the electronic device.

Each of the electrodes may comprise any suitable electrically conductive material. For example, each of the electrodes may comprise a transparent conducting film. A transparent conducting film may comprise inorganic materials, organic materials, or both. An inorganic material of the transparent conducting film herein may refer to a transparent conducting oxide e.g., indium tin oxide (“ITO”), fluorine doped tin oxide (“FTO”), doped zinc oxide, etc. The organic materials may include carbon nanotubes, graphene, poly(3,4-ethylenedioxythiophene), etc. In one example, the electrode comprises at least one of In₂O₃:Sn and SnO₂:F. For example, for the PDLC layer, the conductive ITO layers positioned on both sides of the PDLC material (e.g. on glass layers) may provide suitable electrodes for applying a voltage across the PDLC material.

In the layer comprising PDLC, the crystals need not contact both electrodes. In one example, the liquid crystals are in electrical contact with one electrode, while a plurality of prism structures is in contact with the other structure. The prism structures may have any suitable dimensions. For example, the structure may have a thickness of between about 20 μm and about 200 μm e.g., between about 50 μm and about 180 μm, etc. The structure may have a pitch of between about 10 μm and about 40 μm—e.g., between about 12 μm and about 30 μm, etc. The structure may have an apex angle of between about 50° and about 160°—e.g., between about 70 and about 150°, etc.

In one example, the prism structures are in contact with the electrode closer to the display, while the crystals are in contact with the electrode farther away from the display. In another example, the configuration is the other way around. The prism structures may be bonded to an electrode by an adhesive. The bonding may be, for example, direct bonding. The adhesive may comprise at least one of optical clear adhesive and optical dear resin. Examples of the adhesive include aliphatic polyether urethane oligomers, polyacrylate, urethane (meth)acrylate copolymer, vinyl ester, hydroxyl-terminated polydimethylsiloxane, a sulfydryl alkoxy silane, etc. The prism structures may comprise any suitable material(s). For example, the prism structures may comprise at least one of polyethylene terephthalate (“PET”), polyethylene naphthalate (“PEN”), polyimide (“PI”), polycarbonate, polyacrylic (e.g., PMMA), polyolefin, and transparent plastic composites. The prism structures may have any suitable geometry, such as triangle, rectangle, hexagon, etc. The prism structures may be employed to re-direct light by using internal reflection. As a result, the structures may enchase light transmission efficiency.

Electrochromic Device

The second device as a part of the display-containing article described herein may be electrochrornic device providing an electrochromic effect to the article. The electrochromic device herein may comprise an electrochromic layer comprising an electrochromic material and at least one electrode.

An electrochromic material may refer to a material that changes color in a persistent but reversible manner by an electrochemical reaction—this phenomenon is also known as electrochromism. Electrochromism may refer to the reversible and visible change in transmittance and/or reflectance that is associated with an electrochemically induced oxidation-reduction reaction. In one example, it results from the generation of different visible region electronic absorption bands on switching between redox states. The color change may be between a transparent (“bleached”) state and a colored state, or between two colored states. In the case where more than two redox states are electrochemically available, the electrochromic material may exhibit several colors and may be referred to as polyelectrochromic. This optical change is effected by a small electric current at low DC potentials of the order of a fraction of volts to a few volts.

The electrochromic material in the electrochromic device may be in electrical contact with at least one electrode. Electrical contact may involve, physical contact or no physical contact. In the case of non-physical contact, the electrode may be electrically connected to the electrochromic material using a wire. For example, the electrochromic device may share at least one electrode with another device when the two devices are employed in combination, and the shared electrode may be electrically connected to the electrochromic material using a wire. In one example, the electrochromic material sandwiched between a first electrochromic electrode and a second charge balancing counter electrode. As a result, the color changes may occur by charging and discharging the electrochemical cell with an applied potential. In one example, after the resulting pulse of current has decayed and the color change has been effected, the new redox state persists, with little or no input of power—sometimes referred to as “memory effect”.

The electrochromic device may operate in either a reflective mode or a transmissive mode. The electrodes may comprise any suitable material that electrically conductive. In one example, the electrochromic electrode is an electrically conductive transparent glass, and the counter electrode may comprise any material that provides a reversible electrochemical reaction. The electrode of the electrochromic device described herein may be the same as those employed in the privacy device described above. For example, the electrode may comprise a transparent conducting film.

The electrochromic device herein may facilitate filtering out, light of certain wavelengths so that these filtered-out light do not, or at least minimally, reach the user of the article. The light to be filtered out may vary, depending on the applications. For example, the light to be filtered out may be blue light in the visible light spectrum.

The electrochromic material may comprise at least one transition metal oxide, organic molecules, or both. In one example, the electrochromic material comprises at least one of WO₃, MoO₃, TiO₂, Ta₂O₆, Nb₂O₅, CeVO₄, SnO₂, IrO₂, CoO₂, MnO₂, FeO₂, Cr₂O₃, RhO₂, and V₂O₅. In another example, the electrochromic material comprises Prussian yellow (PY: KFe′″[Fe′″(CN)₆]). In another example, the electrochromic material comprises yellow conjugate polymers comprising a sequence of dioxythiophene units alternating with aromatic units, thiophene units, furan units, and/or pyrrole units, biphenyl-4,4′-diamine derivatives, 2,4,6-triphenyl-1,4′-bipyridine-1,1′-diium derivatives, viologen derivatives, pyridine derivatives, cyanine derivatives, and/or styryl derivatives. Other types of materials are also possible.

Electron Display with Privacy Device and Electrochromic Device

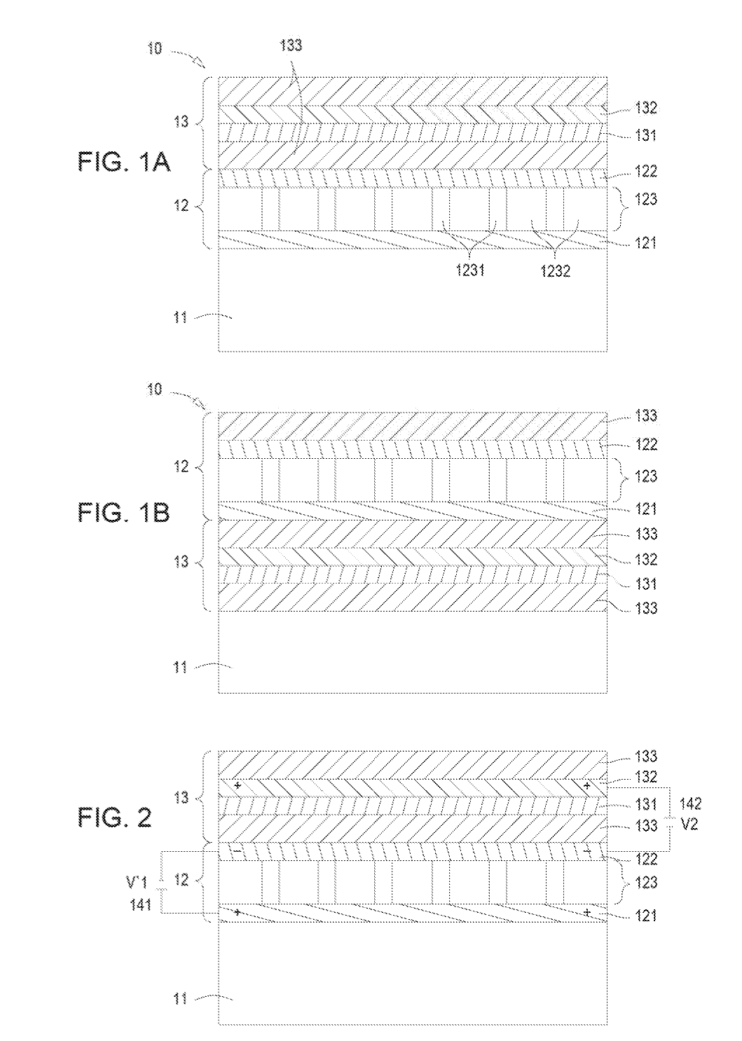

FIGS. 1-7 are schematics illustrate different examples of the article described herein. FIG. 1A shows an article 10 having a substrate 11 that is an electronic display. In the article 10, disposed over the substrate 11 is the first device 12, and disposed over the first device 12 is the second device 13. It is noted that the figures herein show that the first device is disposed over the entire top surface of the substrate and the second device over the entire top surface of the second device, but this need not be the case. Specifically, the first device may be disposed over a portion of the substrate and the second device may be disposed over a portion of the first device.

The first device 12 may be a privacy device as described herein. The second device 13 may be an electrochromic device as described herein. As shown in FIG. 1A, the first device may comprise a first electrode 121 and a second electrode 122, which sandwich a PDLC-containing layer 123. The PDLC containing layer 123 may comprise liquid crystals 1231 dispersed in a polymer matrix 1232 (hence polymer dispersed liquid crystals). The first electrode 121, the second electrode 122, and the PDLC-containing layer 123 may be any of those as described herein.

The second device 13 may comprise an electrochromic layer 131 comprising an electrochromic material, such as any of those described herein. The second device may comprise a third electrode 132 in electrical contact with the electrochromic layer 131. It is noted that to the extent applicable, the terms “first,” “second” “third,” etc. herein are merely employed to show the respective objects described by these terms as separate entities and are not meant to connote a sense of chronological order, unless stated explicitly otherwise herein. The second device 13, as well as the first device 12, may further comprise at least one layer 133 comprising at least one of a glass and a plastic material separating the different components. In other words, in the second device 13 a first insulating layer comprising the insulating material is in contact with the second electrode 122 of the first device 12, and a second insulating layer comprising the insulating material disposed over at least a portion of the third electrode 132. The term ‘contact’ herein may refer to physical contact, electrical contact, or both. The insulating material may be at least one of a glass and a plastic material. It is noted that these layers 133 may be placed at any suitable locations and need not be only as shown in the figures.

FIG. 1B is a schematic diagram illustrating another example of the article described herein. Unlike FIG. 1A, the electrochromic device is disposed over the display substrate and the privacy device is disposed over the electrochromic device—i.e., the first device is disposed over the second device, which is disposed over the substrate. In other words, the relative position of the electrochromic device and the privacy device of FIG. 1A with respect to the substrate is switched herein in FIG. 1B.

FIG. 2 is a schematic illustrating another example of the article described herein. FIG. 2 shows an article similar to that shown in FIG. 1 but is switchable. Specifically, the first and second devices may be switched on and off by applying two voltages V1 and V2, labelled as 141 and 142. As a result, the functionalities of privacy and blue light block may be managed by switchable controller to select either privacy control mode or blue light block mode. As shown in FIG. 2, the voltage 141 applied to the first device 12 and the voltage 142 applied to the second device 13 may be employed to turn on/off the respective devices, thus selectively providing the respective functionalities to the article. In the example as shown in FIG. 2, the first device 12 and second device 13 share the second electrode 122 as a negative electrode for both the positive (first) electrode 121 of the first device 12 and the positive (third) electrode 132 of the second device 13. It is noted also that the negativity and the positivity of the electrodes as shown in the figure may be reversed.

Additionally, as described above, the voltages applied here may be of any suitable values, depending on the applications. The first voltage 141 and the second voltage 142 may be the same or different from each other, in one example, the first voltage 141 is larger than the second voltage 142. In another example, the first voltage 141 is smaller than the second voltage 142. In one example, the first voltage is between about 15 V and about 40V. In one example, the second voltage 142 is between about 3 V and about 15 V.

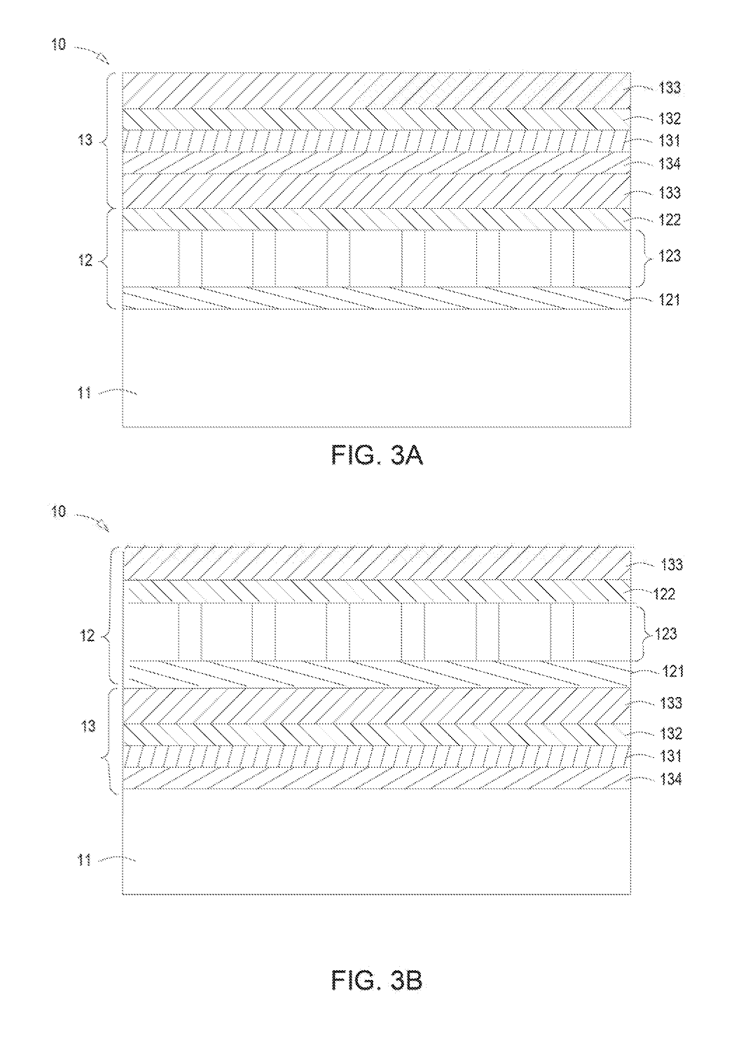

FIG. 3A is a schematic illustrating another example of the article described herein. FIG. 3A shows an article similar to that shown in FIG. 1A, but in the article of FIG. 3A the first device 12 and the second device 13 do not share a common electrode. Instead, the second electrode comprises a fourth electrode 134, and the third electrode 132 and the fourth electrode 134 sandwich the electrochromic layer 131.

FIG. 3B is a schematic diagram illustrating another example of the article described herein. Unlike FIG. 3A, the electrochromic device is disposed over the display substrate and the privacy device is disposed over the electrochromic device. In other words, the relative position of the electrochromic device and the privacy device of FIG. 3A with respect to the substrate is switched herein in FIG. 3B.

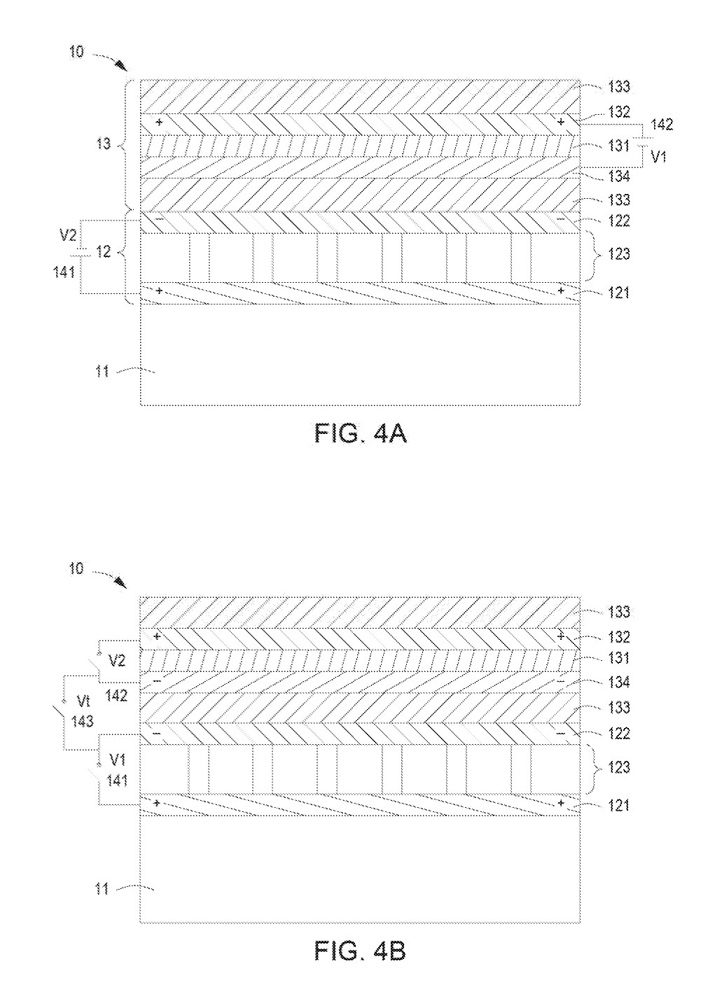

FIG. 4A is a schematic illustrating another example of the article described herein. FIG. 4A shows an article similar to that shown in FIG. 3, but is switchable. Similar to FIG. 2 with respect to FIG. 1A, the first device 12 and second device 13 of the article of FIG. 4A may be switched on and off by external voltages 141 and 142. FIG. 4B illustrates another example, wherein the first voltage 141 and the second voltage 142, such as those shown in FIG. 4A, may be controlled by another voltage source 143.

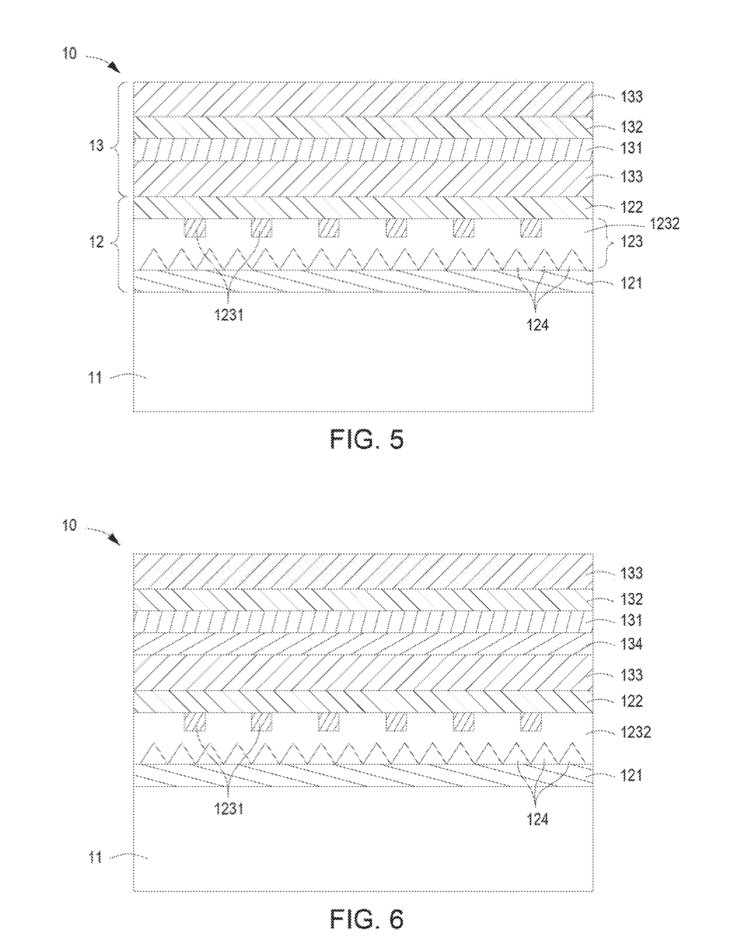

FIGS. 5 and 6 are schematics illustrating additional examples of the article described herein. Specifically, FIG. 5 shows an article similar to that shown in FIG. 1A, except the PDLC-containing layer comprises both PDLL and prism structures 124, whereas FIG. 6 shows an article similar to that shown in FIG. 5 except the first device 12 and second device 13 do not share a common electrode. The prism structures 124 may be any of those described herein. It is noted that in FIGS. 5 and 6, the liquid crystals 1231 are located above the prism structures 124. However, this need not be the case, and the reverse may be possible.

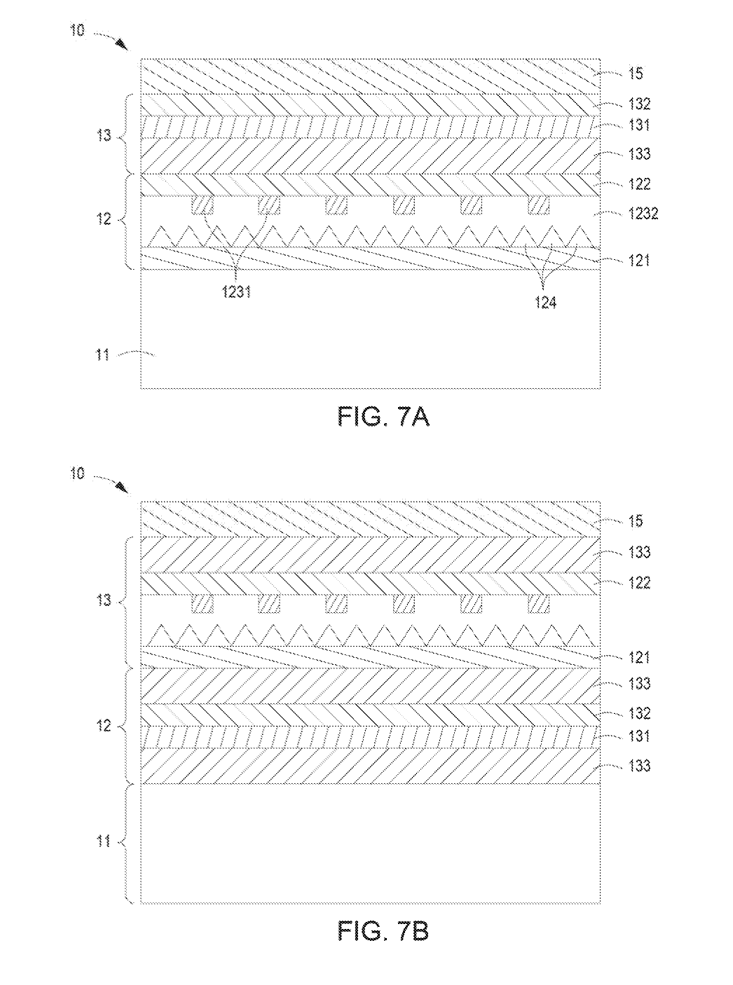

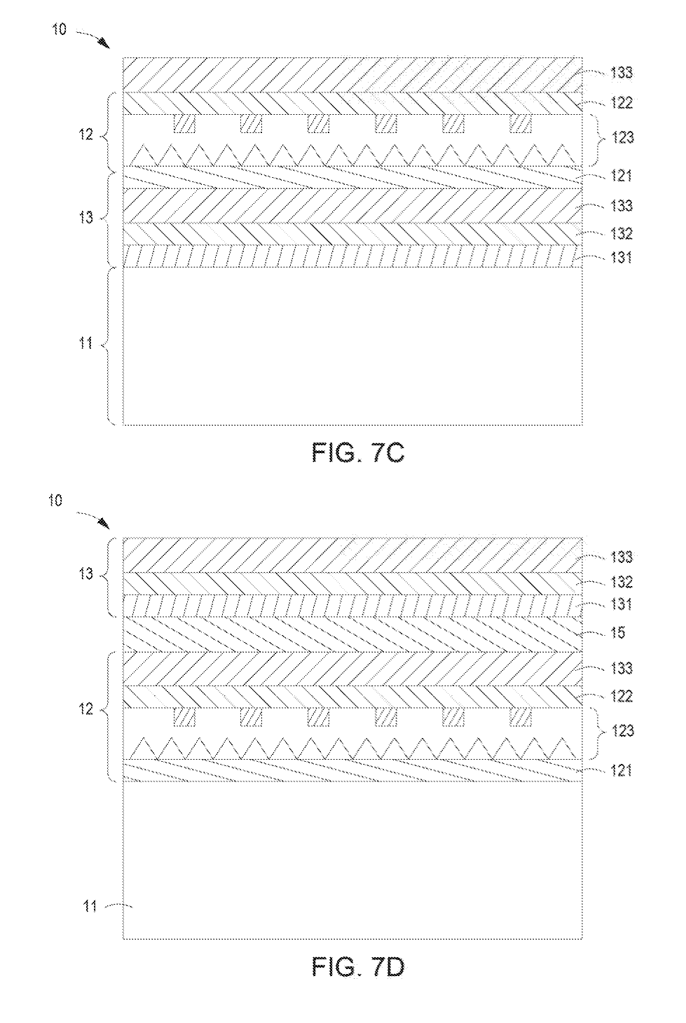

FIGS. 7A-7D are schematics illustrating additional examples of the article described herein. Specifically, in these figures, a touch sensor 15 is additionally employed. FIG. 7A shows that the touch sensor 15 is disposed over the second device of the article 10, which is similar to that shown in FIG. 5. In the example as shown in FIG. 7A, the touch sensor 15 then is the outermost layer of the article. FIG. 7B is a schematic diagram illustrating another example of the article described herein. Unlike FIG. 7A, the electrochromic device is disposed over the display substrate and the privacy device is disposed over the electrochromic device. FIG. 7C shows an example wherein on additional touch sensor 15 is employed, but the substrate 11 is an electronic display with in-cell touch sensor. It is noted that while the privacy device 12 is disposed over the electrochromic device 13 (e.g., farther away from the display), the positions of these two devices may be switched. FIG. 7D shows an example wherein the touch sensor 15 is located between the first device 12 and the second device 12, and blot in the exterior of the article. In the example as shown in FIG. 7D, the touch sensor 15 is placed below the electrochromic layer 131. However, it is also possible that the touch sensor is placed over the electrochromic layer 131, as well as the third electrode 132.

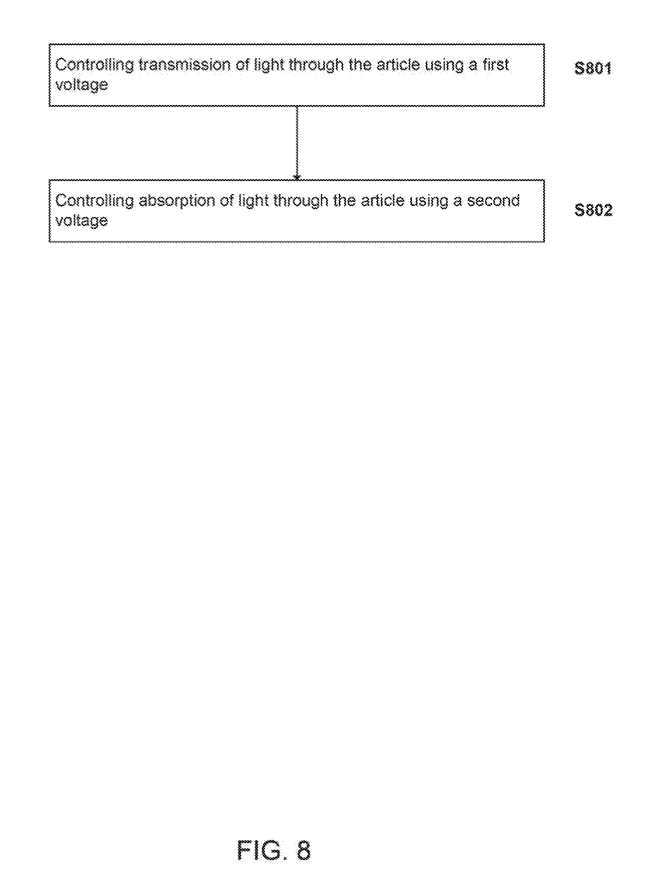

The articles described herein may be employed for a variety of applications. FIG. 8 provides a flowchart illustrating the processes involved in such a method. The article may be used to control transmission of light through the article using a first voltage (S801). The article may also be used to control absorption of light through the article using a second voltage (S802). The article may be any of those described herein. The voltages may be applied to the first and second devices as described herein. The absorption of light herein may refer to light of certain wavelengths. For example, the second device of the article described herein may be employed to absorb blue light in the visible light spectrum, thus rendering the display for eye-friendly for a user. The method may also comprise making the article. The method of making may comprise, for example, assembling the first device, the second device, and the substrate.

As a result, the articles described herein may provide a switchable privacy control and eye-friendly operation display solution to ensure information security with eye protection. The user may manage switchable controller to have the selective operation on privacy control mode, blue light block mode or privacy/blue light block modes both by touch sensor. Specifically, due in part to the (first) privacy device, the articles may be used to a notebook computer or the screen of a desktop monitor from prying eyes. Additionally, due in part to the (second) electrochromic device, the articles may reduce radiation and glare generated from LCD and OLED displays for a long-time user with the eye-protection function, especially for blue light. The prism structure in some examples may enhance light efficiency. Additionally, in one example the articles allow the user to select the mode of operations (i.e., privacy control mode, blue light block mode or privacy/blue light block modes both) by touch sensor.

Additional Notes

It should appreciated that all combinations of the foregoing concepts (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

The indefinite articles “a” and “an,” as used herein in this disclosure, including the claims, unless clearly indicated to contrary, should be understood to mean “at least one.” Any ranges cited herein are inclusive.

The terms “substantially” and “about” used throughout this disclosure, including the claims, are used to describe and account for small fluctuations. For example, they may refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

Concentrations, amounts, and other numerical data may be expressed or presented herein in a range format. Such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited, As an illustration, a numerical range of “1 weight % (wt %) to 5 wt %” should he interpreted to include not only the explicitly recited values of 1 wt % to 5 wt %, but also include individual values and sub-ranges within the indicated range. Thus, included in this numerical range are individual values, such as 2, 3.5, and 4, and sub-ranges, such as from 1-3, from 2-4, and from 3-5, etc. This same principle applies to ranges reciting only one numerical value. Furthermore, such an interpretation should apply regardless of the breadth of the range or the characteristics being described.

The phrase “and/or,” as used herein in this disclosure, including the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined, Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” may refer, in one example, to A only (optionally including elements other than in another example, to B only (optionally including elements other than A); in yet another example, to both A and B (optionally including other elements); etc.

As used in this disclosure, including the “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in this disclosure, including the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and or B”) may refer, in one example, to at least one, optionally including more than one, A, with no B present (and optionally including elements other than B); in another example, to at least one, optionally including more than one, B, with no A present (and optionally including elements other than A); in yet another example, to at least one, optionally including more than one, A, and at least one, optionally including more than one, B (and optionally including other elements); etc.

In this disclosure, including the claims, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, § 2111.03.

What is claimed:

1. An article, comprising:
a substrate that is an electronic display:
a first device disposed over the substrate; and
a second device disposed over the substrate;
wherein
the first device comprises:
a first electrode;
a second electrode; and
polymer dispersed liquid crystals disposed between the first electrode and the second electrode; and
the second device comprises:
an electrochromic layer comprising an electrochromic material; and
a third electrode in electric contact with the electrochromic layer.

2. The article of claim 1, wherein:
the first device is disposed over the substrate and the second device is disposed over the first device; or
the second device is disposed over the substrate and the first device is disposed over the second device.

3. The article of claim 1, wherein at least one of the first electrode, the second electrode, and the third electrode is a transparent conductive film.

4. The article of claim 1, wherein the polymer dispersed liquid crystals are dispersed in a matrix comprising at least one of a glass and a plastic.

5. The article of claim 1, wherein the first electrode and the second electrode are connected to a first voltage source, and the second electrode and the third electrode are connected to a second voltage source.

6. The article of claim 1, wherein the electrochromic material comprises at least one of WO₃, MoO₃, TiO₂, Ta₂O₅, Nb₂O₅, CeVO₄, SnO₂, IrO₄, CoO₂, MnO₂, FeO₂, Cr₂O₃, RhO₂, V₂O₅, Prussian yellow, and a yellow conjugated polymer comprising a sequence of dioxythiophene units alternating with at least one of aromatic units, thiophene units, furan units, pyrrole units, biphenyl-4,4′-diamine derivatives, 2,4,8-triphenyl-1,4′-bipyridine-1,1′-diium derivatives, viologen derivatives, pyridine derivatives, cyanine derivatives and styryl derivatives.

7. The article of claim 1, further comprising a fourth electrode in the second device, such that the electrochromic layer is sandwiched between the third electrode and the fourth electrode.

8. The article of claim 1, wherein the first device further comprises a plurality of prism structures comprising at least one of polyethylene terephthalate, polyethylene naphthalate, polyimide, polycarbonate, polyacrylic, polyolefin, and a transparent plastic composite, the prism structures in contact with the first electrode and the polymer dispersed liquid crystals in contact with the second electrode.

9. The article of clam 1, further comprising a touch sensor disposed over at least a portion of the second device, such that the touch sensor is exterior to the first device and second device.

10. The article of claim 1, further comprising a touch sensor disposed between the first device and the second device.

11. An article, comprising:
substrate that is an electronic display;
a first device disposed over at least a portion of the substrate; and
a second device disposed over at least a portion of the first device;
wherein
the first device comprises:
a first electrode in contact with the substrate;
a second electrode; and
polymer dispersed liquid crystals disposed in a matrix comprising an insulating material between the first electrode and the second electrode; and
the second device comprises:
a first insulating layer comprising the insulating material;
an electrochromic layer comprising an electrochromic material disposed over at least a portion of the first insulating layer;
a third electrode disposed over and in electrical contact with at least a portion of the electrochromic layer;
a second insulating layer comprising the insulating material disposed over at least a portion of the third electrode.

12. The article of claim 11, wherein the second electrode is shared by the first device and the second device.

13. The article of claim 11, wherein the first device further comprises a plurality of prism structures comprising at least one of polyethylene terephthalate, polyethylene naphthalate, polyimide, polycarbonate, polyacrylic, polyolefin, and a transparent plastic composite, the prism structures in contact with the first electrode and the polymer dispersed liquid crystals in contact with the second electrode.

14. A method of using article, comprising:
controlling transmission of light through the article using a first voltage; and
controlling absorption of light through the article using a second voltage;
wherein the article comprising:
a substrate that is an electronic display;
a first device disposed over at least a portion of the substrate; and
a second device disposed over at least a portion of the first device;
wherein
the first device comprise
a first electrode;
a second electrode; and
polymer dispersed liquid crystals disposed between the first electrode and the second electrode;
the second device comprises:
an electrochromic layer comprising are electrochromic material; and
a third electrode in electrical contact with the electrochromic layer; and
wherein the first voltage is applied to the first device and the second voltage is applied to the second device.

15. The method of claim 14, further comprising a method of making the article, the method of making comprising:
assembling the first device, the second device, and the substrate.
